(19) United States
(12) Patent Application Publication
(10) Pub. No.: US 2024/0037415 A1
(43) Pub. Date: Feb. 1, 2024

(54) PREDICTING DISCRETE OUTCOMES IN COMPUTER APPLICATIONS USING MACHINE LEARNING MODELS ON TIME SERIES DATA INSTANCES

(71) Applicant: INTUIT INC., Mountain View, CA (US)

(72) Inventor: Prateek ANAND, San Diego, CA (US)

(73) Assignee: INTUIT INC., Mountain View, CA (US)

(21) Appl. No.: 17/815,551

(22) Filed: Jul. 27, 2022

(51) Int. Cl. G06N 5/02

(52) U.S. Cl. CPC G06N 5/022

(57) ABSTRACT

Systems and methods may predict whether a user will abandon an application. Initially, different features are extracted from a time series of numerical values rendered by the application. A machine learning model is trained using a supervised approach on the extracted features to map the known and labeled outputs. In this supervised approach, the output may be binary with a “0”-label for a user that has left the application in the middle of a task and a “1”-label for the user who has used the application to finish the task. During the deployment, the trained model may be called to predict whether the user will abandon the application based on time series of numerical values retrieved in real time. If an abandonment is predicted, a customized message is generated and presented on the user's device.

### BACKGROUND

Computer applications provide front-end functionalities supported by a back-end system. In networked computers for example, a computer application—either through a graphical interface or text interface—allows a user to access different portions of the network, utilize different services provided by the network, and even configure the network. Computer applications, especially those with a computer network back-end, move through a series of interfaces as the user navigates the application to access and implement different functionalities provided by the network.

By definition, computer applications are designed for human use. These applications therefore need to provide user-friendly interfaces with smooth transitions such that the user finds them easy to use. Furthermore, the applications have to be of some value to the users. In the cases where the user pays for applications, a user's perceived value of an application should be commensurate with or should exceed the price for the application. If not, the user may simply close out and leave (i.e., abandon) the application. Algorithms for tracking user engagement have been developed to determine whether the user will continue engaging with the application or abandon it.

Conventional engagement algorithms, however, are inadequate, especially in the context of network-based applications that take the user through a series of interfaces where each interface shows a particular instance of numerical data in response to the user's input. This time series of the data instances will most likely drive the value perception of—and the overall engagement with—the application. But conventional engagement algorithms generally rely upon clickstream data; thus, the conventional engagement models are based on where and how the user has clicked at different interfaces, which may not be representative of the value perception. The time series of data instances are not clickable and modifiable. The time series of data are generally informational only—the data changes based on other user inputs—but it is not directly changeable through clicks. So, the engagement models and other algorithms based on clickstream data do not work for these types of applications.

As such, a significant improvement in user engagement of computer applications, particularly those with non-clickable portions that drive user value perception, is therefore desired.

### SUMMARY

Embodiments disclosed herein solve the aforementioned technical problems and may provide other solutions as well. In one or more embodiments, historical data with a time series of numerical values for an application with known outcomes (e.g., abandonment, non-abandonment) is retrieved. Different features are extracted from the time series. A machine learning model is trained using a supervised approach on the extracted features to map known and labeled outputs. In this supervised approach, the output may be binary with a “0”-label for a user that has left the application in the middle of a task and a “1”-label for the user who has used the application to finish the task. In some embodiments, the machine learning model may include a light gradient boosting machine (GBM). During the deployment of the application, the trained model may be called to predict whether the user will abandon the application based on a time series of numerical values retrieved in real time. If an abandonment is predicted, a customized message is generated and presented with the goal of preventing the abandonment. The customized message may include a discount on the price of the application and or an explanation based on a Shapely model.

In an embodiment, a computer-implemented method of predicting an abandonment of a computer application is provided. The method may include retrieving, in real-time, a time series of numerical values rendered by a sequence of interfaces of the computer application as a user navigates through the computer application and extracting a plurality of features from the time series of numerical values. The method may also include deploying a machine learning model on the plurality of extracted features to determine whether the user will continue using the computer application or abandon using the computer application, wherein the machine learning model was trained using a supervised approach on a plurality of historical features and corresponding labeled outcomes. The method may further include generating a customized message for display by the computer application responsive to determining that the user will abandon using the computer application.

In another embodiment, a system for predicting an abandonment of a computer application is provided. The system includes a non-transitory medium storing computer program instructions and at least one processor configured to execute the computer program instructions to cause operations that may include: retrieving, in real-time, a time series of numerical values rendered by a sequence of interfaces of the computer application as a user navigates through the computer application and extracting a plurality of features from the time series of numerical values. The operations may also include deploying a machine learning model on the plurality of extracted features to determine whether the user will continue using the computer application or abandon using the computer application, wherein the machine learning model was trained using a supervised approach on a plurality of historical features and corresponding labeled outcomes. The operations may further include generating a customized message for display by the computer application responsive to determining that the user will abandon using the computer application.

### BRIEF DESCRIPTION OF THE FIGURES

FIG. 1 shows an example system configured for predicting whether a user will abandon an application, based on the principles disclosed herein.

FIG. 2 shows a flow diagram of an example method of training a machine learning model for predicting whether a user will abandon an application, based on the principles disclosed herein.

FIG. 3 shows a flow diagram of an example method of deploying a trained machine learning model for predicting whether a user will abandon an application, based on the principles disclosed herein.

FIG. 4 shows an example interface displayed during an implementation of one or more principles disclosed herein.

FIG. 5 shows a block diagram of an example computing device that implements various features and processes, based on the principles disclosed herein.

### DETAILED DESCRIPTION OF EXAMPLE EMBODIMENTS

Computer applications may be abandoned by users for various reasons. One reason may be the discrepancy between the value offered by the application vis-à-vis the cost of the application. In the applications such as tax preparation applications where a time series of refund amounts is shown as the user navigates through the various interfaces, the shown time series of refund amounts may drive the value perception for the user. That is, positive and or growing refund amounts will create a positive perception of the application whereas low or negative (i.e., taxes owed) may create a negative perception of the application. Machine learning models may be trained on this time series of data to determine whether the user will abandon the tax preparation application or not. If an abandonment is predicted, a customized message offering e.g., a discount for the application and or an explanation (e.g., based on a Shapely model) of the refund may be generated and presented to the user with the goal of deterring the abandonment.

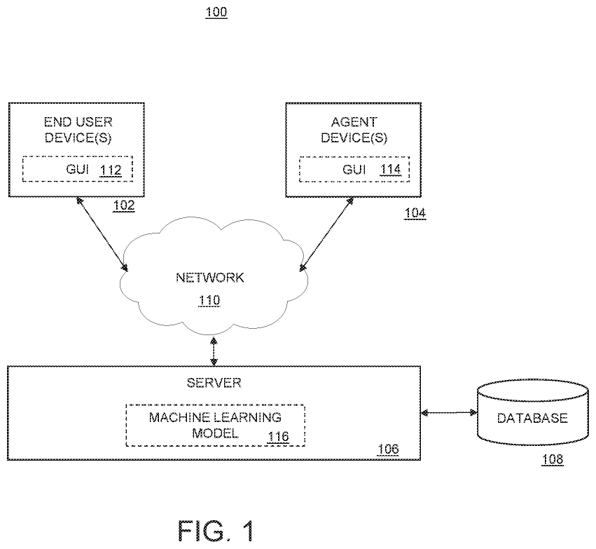

FIG. 1 shows an example system 100 configured for predicting whether a user will abandon an application, based on the principles disclosed herein. As shown, the system 100 comprises end user device(s) 102 (a single instance referred to as an end user device 102 and multiple instances referred to as end user devices 102), agent device(s) 104 (a single instance referred to as an agent device 104 and multiple instances referred to as agent devices 104), a server 106, a database 108, and a network 110. It should, however, be understood these are example components and systems with additional, alternative, or fewer number of components should be considered within the scope of this disclosure.

The end user devices 102 may be operated by corresponding users. Each of the end user devices 102 may include a graphical user interface (112) that renders an application to access and or modify different functionalities provided by the system 100. The user devices may include, for example, mobile computing devices (e.g., smartphone), tablet computing devices, laptop computing devices, desktop computing devices, and or any type of computing devices. Users may include individuals such as, for example, subscribers, customers, clients, or prospective clients, of an entity associated with the server 106. The users may generally use the application rendered on the GUI 112 to access the server 106. In some instances, the application may include a TurboTax® product offered by Intuit of Mountain View, California.

The agent devices 104 may be operated by service provider users in the system 100. The service provider users may include, for example, customer service specialists that interact with the users through the corresponding graphical user interfaces 114. In other words, the users and the agents may interact with one another through their graphical user interfaces 112, 114. The agent devices 104 may include, for example, mobile computing devices (e.g., smartphone), tablet computing devices, laptop computing devices, desktop computing devices, and or any type of computing devices.

The network 110 may include any type of network configured to provide communication functionalities within the system. To that end, the network 110 may include the Internet and or other public or private networks or combinations thereof. The network 110 therefore should be understood to include any type of circuit switching network, packet switching network, or a combination thereof. Non-limiting examples of the network 110 may include a local area network (LAN), metropolitan area network (MAN), wide area network (WAN), and the like.

The server 106 may include any type of computing device or combination of computing devices. Non-limiting examples the computing devices forming the server 106 include server computing devices, desktop computing devices, laptop computing devices, and or the like. The server 106 may also include any combination of geographically distributed or geographically clustered computing devices. The server 106 may include a machine learning model 116 (not to be construed as a single machine learning model) that may be trained and deployed using one or more embodiments disclosed herein. The server 106 may be in communication with or host a database 108. The database 108 may include any kind of database. Some non-limiting examples of the database 108 include, a relational database, an object-oriented database, and or the like.

The machine learning model 116 may be trained based on features extracted from a time series of numerical values from the interfaces rendered by an application via the graphical user interfaces 112 of the end user devices 102. For example, if the application is for filing an electronic tax return (i.e., a tax preparation application), interfaces presented by the application may show a refund amount (federal, state, or a sum of both) as the user progresses through entering of the tax related information. The value proposition for the user to pay for the tax preparation application may be based on the amount of refund that application generates and presents on the interfaces. A time series of the amount of refunds generated may then be used to predict whether the user will continue using and subsequently pay for the tax preparation application. If the perceived value based on the refund is not commensurate with the price, the user may simply abandon the tax application without paying for it. Embodiments disclosed herein mitigate this abandonment problem by proactively predicting a potential abandonment and generating customized messages (e.g., discounts and or explanations) to deter the abandonment.

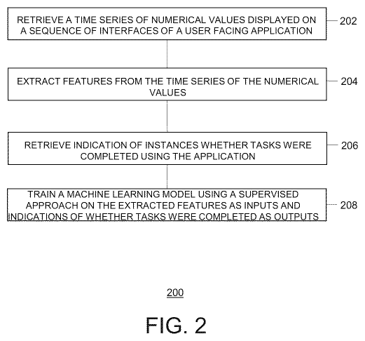

FIG. 2 shows a flow diagram of an example method 200 of training a machine learning model for predicting whether a user will abandon an application, based on the principles disclosed herein. The steps of the method 200 may be performed by one or more components of the system 100 shown in FIG. 1 to train the server's model 116. It should also be understood that the steps shown in FIG. 2 and described herein are merely examples, and methods with additional, alternative, or fewer number of steps should be considered within the scope of this disclosure. It should further be understood that the discrete steps and their order is merely an example and is not for showing a sequence of operations.

At step 202, a time series of numerical values displayed on a sequence of interfaces on a user facing application may be retrieved. In an example, the user facing application may be a tax preparation application and the numerical values may be the refund amounts (federal, state, or a sum of both) predicated at that stage of the application. The data may be historical data that may be spread across many users and many years. For these different users, the data may show the sequence of refund(s) shown to the users as they traverse the tax preparation application until the users complete the tax return or abandon the tax preparation application (i.e., “churn”). It has been found that users traverse through an average of 200 interfaces for filing a tax return, but in some embodiments only 50 (out of the 200) of the interfaces may be retrieved and or selected after retrieval. However, using a time series of 50 refund amounts through the corresponding interfaces is merely an example, and the lookback length can be increased or decreased in other embodiments.

In step 204, features may be extracted from the retrieved time series of numerical values. Continuing with the above described tax preparation application example, the numerical values may represent refund amounts seen by a user as the user traverses through the different interfaces of the tax preparation application. Some example features are described below. It should, however, be understood that these are example features and should not be considered limiting. Additional, alternative, or fewer features may be used without deviating from the embodiments of this disclosure.

Feature 1: Symmetricity of the time series distribution. This feature indicates whether the distribution of the time series of the refund amounts (state, federal, or a sum of both) is symmetric. Mathematically, a distribution is symmetric for a random variable X when |mean (X)−median(X)|<(max (X)−min(X)), where r=0.5. Here, the random variable X is the time series of refund amounts.

Feature 2: Non-linearity of the time series. The non-linearity features may be extracted using the mathematical models described in “On the discrimination power of measures for nonlinearity in a time series” by T. Schreiber and A. Schmitz (Phys. Rev. E 55, 5443 (1997)).

Feature 3: Complexity measurements. A first complexity measurement of the time series may be based on Lempel-Ziv compression, as known in the art. Generally, this complexity measurement indicates the compressibility of the time series data. For instance, the data is less compressible when there is a large number of unique values, but more compressible when there is a smaller number of unique values. Another measure of complexity may be based on complexity invariant distances as proposed in the paper “CID: an efficient complexity-invariant distance for time series” by Batista et al. (2013).

Feature 4: Entropy of time series. The entropy of the time series indicates the homogeneity of the data. A non-homogenous data set generally has frequently changing data (e.g., refund amounts). For instance, if there is no change, the entropy value may be 0, and if the refund amount changes every interface, the entropy value is 1.

Feature 5: Sum of squared values of the time series. The sum of squared values is a statistical property of the time series. The sum of square values provides a sum of a square of the variation, where the variation is spread between each value and a mean. A line of best fit will minimize this value.

Feature 6: Number of peaks of support n in the time series. A peak of support n is defined as a sub-sequence of the time series where a value occurs, in which the value is larger than its n neighbors to the left and right. For instance, a peak of support with n=5 is defined as sub-sequence where the largest value in the sub-sequence is larger than 5 of its neighbors to its left and right. However, it should be understood that peak of support with n=5 is just an example, and a peak of support of any number should be considered within the scope of this disclosure.

Feature 7: Autocorrelation with a lag value=2. To calculate this autocorrelation the time series is shifted by two positions and autocorrelated with the original, non-shifted time series. Mathematically, an example correlation will be between positions t=0 and t=2, t=1 and t=3, and so on.

Feature 8: Value in the time series that is greater than 75% of the ordered values from the time series. For example, if the refund amounts are arranged in an ascending order (and not necessarily in their original temporal sequence), this feature includes values that are over the 75% of the ordered values.

Feature 9: Number of times a subsequence of size 3 occurs where the first value is negative, and the third value is positive or vice versa. This feature may capture the instances when the refund amount flips (e.g., from a situation where the user has to pay additional taxes to a situation whether the user will receive a refund, or vice versa). For example, a flip from negative to positive may increase the likelihood that the user will complete the tax return using the tax preparation application and flips from positive to negative may increase the likelihood that the user will abandon the tax preparation application.

Feature 10: Whether the standard deviation is higher than 4 times the range of time series: The range of the time series is defined as max(X)−min(X). When this range is compared to 4 times the standard deviation, the answer may be either “yes” (4*std. dev. higher than the range) or “no” (4*std. dev. lower than the range). This feature may therefore indicate whether there is a high degree of variability in the time series data.

Feature 11: Ratio of values more than 2 times the standard deviation away from the mean of the time series. To extract this feature, a mean (e.g., an arithmetic mean) of the time series may be first calculated. Then, values in the time series that are more than 2 standard deviations away from the calculated mean are identified. Corresponding ratios of these values are calculated to extract this feature.

Feature 12: Percentage of repeated values. For each repeated value in the sequence (e.g., the same refund amount seen by the user across different interfaces), the number of times the value repeats is divided by the total number of values. This calculation may indicate how often each value repeats in the time series.

Feature 13: First position of the minimum value: The minimum value may be considered the worst possible outcome for the user. This feature may therefore indicate, given where the user is, how far is the user from the worst possible outcome.

Feature 14: First position of the maximum value: The maximum value may be considered the best possible outcome for the user. This feature may therefore indicate, given where the user is, how far the user is from the best possible outcome.

Feature 15: Last position of the minimum value. The minimum value may be considered the worst possible outcome for the user. This feature may therefore indicate given where the user is, how far the user is from the worst possible outcome.

Feature 16: Last position of the maximum value: The maximum value may be considered the best possible outcome for the user. This feature may therefore indicate, given where the user is, how far the user is from the best possible outcome.

Feature 17: Length of a consecutive subsequence greater than the mean. After calculating the mean (e.g., arithmetic mean) of the time series, this feature records a consecutive subsequence that is greater than the mean (e.g., the sub-sequence may have fluctuating values, but these values never go below the mean). This feature may have both the length of the sub-sequence and the values in the sub-sequence.

Feature 18: Length of a consecutive subsequence less than the mean. After calculating the mean (e.g., arithmetic mean) of the time series, this feature records a consecutive subsequence that is less than the mean (e.g., the sub-sequence may have fluctuating values, but these values never go above the mean). This feature may have both the length of the sub-sequence and the values in the sub-sequence.

Feature 19: Sum over the absolute value of consecutive changes in the series. To calculate these features, the absolute differences between consecutive values are calculated and then summed. Mathematically, this may be represented as a sum of |X(t+1)−X(t)| over 0<=t<=n−1 for a time series having n (e.g., 50) values.

Feature 20: Number of distinct values in the time series. This feature indicates the number of distinct (i.e., unique) values in the time series.

Feature 21: Kurtosis of the time series. The Kurtosis of the time series indicates whether the time series distribution is heavy-tailed or light-tailed relative to a Gaussian normal distribution.

Feature 22: Skewness of the time series. The skewness measures asymmetry of the distribution of the time series, e.g., degree of how the series is left leaning or right leaning.

Feature 23: Number of values greater than the mean in the time series. This feature indicates how many values are greater than the mean in the time series.

Feature 24: Mean over the absolute differences between consecutive values in the time series. This feature first calculates all instances of absolute differences: |X(t+1)−X(t)| over 0<=t<=n−1, and then takes a mean (e.g., arithmetic) of the absolute differences.

Feature 25: Whether duplicate value exists in the time series. This feature indicates whether values (e.g., refund amounts) appear more than once in the time series.

Referring again to method 200, at step 206 an indication of whether tasks were completed using the application is retrieved. Continuing with the above example of a tax return, a task completion indicates that the user has completed (e.g., filed) the tax return using the tax preparation application. If the task (e.g., tax preparation) was not completed, the user has abandoned the tax application (i.e., churned).

At step 208, a machine learning model may be trained using a supervised approach on the extracted features as inputs and the indications of whether the tasks were completed as outputs. If the task was completed, the output may be labelled as a “1” and if the task was not completed, the output may be labelled as a “0.” This labeling will allow the machine learning model to be trained using a supervised approach, i.e., the machine learning model attempts to reduce errors (e.g., by back-propagation) in predicting known outputs. In some embodiments, the machine learning model may be a light Gradient Boosting Model (GBM). The light GBM therefore learns the input patterns that either cause a churn (i.e., output=“0”) or no-churn (i.e., output=“1”).

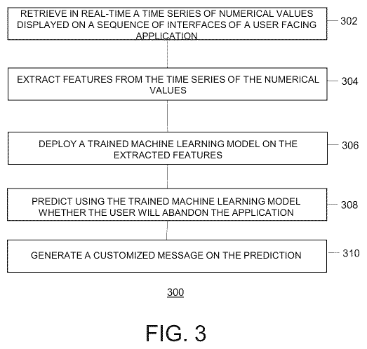

FIG. 3 shows a flow diagram of an example method 300 of deploying a trained machine learning model for predicting whether a user will abandon an application, based on the principles disclosed herein. The steps of the method 300 may be performed by one or more components of the system 100 shown in FIG. 1 to deploy the server's model 116. It should also be understood that the steps shown in FIG. 3 and described herein are merely examples, and methods with additional, alternative, or fewer number of steps should be considered within the scope of this disclosure. It should further be understood that the discrete steps and their order is merely an example and is not for showing a sequence of operations.

At step 302, a time series of numerical values displayed on a sequence of user interfaces of a user facing application may be retrieved in real-time. For example, the sequence of interfaces may be displayed by a tax preparation application and the time series of the numerical values may comprise tax refund amounts (federal, state, or sum of both), both positive and negative. In one or more embodiments, 50 of the values (e.g., tax refund amounts) may be retrieved at this step. As the method 300 may be invoked at any point in the user's journey of completing the tax return, sometimes 50 instances of the refund amount are not available (e.g., the user may have just started the return). In these instances, the list of refund amounts may be pre-pended with zeroes such the size of the list gets to 50. It should be, however, understood that the use of 50 values is just an example and that the lookback time can be adjusted to be more than 50 or less than 50.

At step 304, features from the time series of numerical values are extracted. Several examples of the extracted features are described in relation to step 204 of method 200 shown in FIG. 2. The features extracted at this step may be similar to the aforementioned examples.

At step 306, a trained machine learning model may be deployed on the extracted features. The trained machine learning model may have been trained using the method 200. In some instances, the trained machine learning may be the light GBM discussed above.

At step 308, an outcome of whether the user will abandon the application may be predicted using the trained machine learning model. The outcome may be a “0” indicating that the user will abandon the application or a “1” indicating that the user will continue using the application until task completion (e.g., completion of the tax return).

At step 310, a customized message may be generated and present to the user's device based on the prediction at step 308. The customized message may include, for example, a discount for the tax application.

In one or more embodiments, the customized message may be based on a Shapely model. Shapely models generally indicate a magnitude of how one feature pushes toward the ultimate outcome. For instance, the model training and deployment may establish a baseline based on several features, where the baseline indicates whether the user will continue or abandon. Each individual feature contributes toward this baseline. One feature, for example, Feature 9 that indicates a flip from a positive amount (i.e., the user gets a refund) to a negative amount (i.e., the user has to pay additional taxes), may have a large contribution towards a “0” outcome. In this case, the message can be customized to indicate, “Deduction X may drastically lower your tax burden, have you considered it?” Another example message may be “Congratulations, you qualify for a discount in this tax preparation application, please continue to the next step to redeem your discount.” The amount of discount also may be based on the Shapely model. For instance, one Shapely value (based on the Shapely model) may indicate the user's propensity of abandoning based on a decrease in the refund amount. The decrease in refund can be used to calibrate the discount. In a rather simplistic case, the discount may be exactly the same as the amount of decrease in the refund. These examples of using the Shapley model are just for illustrations and should not considered limiting.

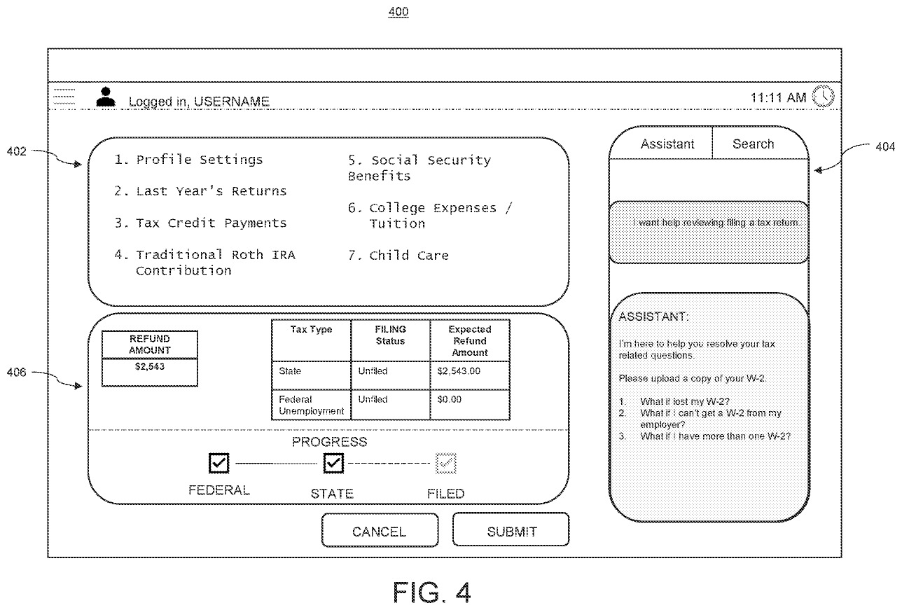

FIG. 4 shows an example interface 400 displayed during an implementation of one or more principles disclosed herein. In particularly, the example interface 400 shows an interface of a tax preparation application. As shown, the interface 400 includes a progress window 402, a refund window 404, and a refund window 406. The progress window 402 may show the different steps of the tax filing process such the user can track where he or she is with respect to completing the tax return. The assistance window 404 may allow the user to seek assistance, e.g., using a chat functionality. The refund window 406 may sow the current refund amount. The current refund amount may include federal refund, state refund, or a sum of both. The refund amount in the refund window 406 may be continuously tracked to determine whether the user will abandon the tax application, in accordance with the principles disclosed herein.

The disclosed principles provide a technical solution to a technical problem that only arises in computer applications, particularly applications providing an electronic service (e.g., filing of an electronic tax return). The disclosed principles operate in real-time as the application is being executed and extracts real-time time series data that is used with a previously trained machine learning model trained on numerous features disclosed herein. Massive amounts of data may be retrieved and processed during the disclosed principles, which provide better predictions than known clickstream-based prediction techniques.

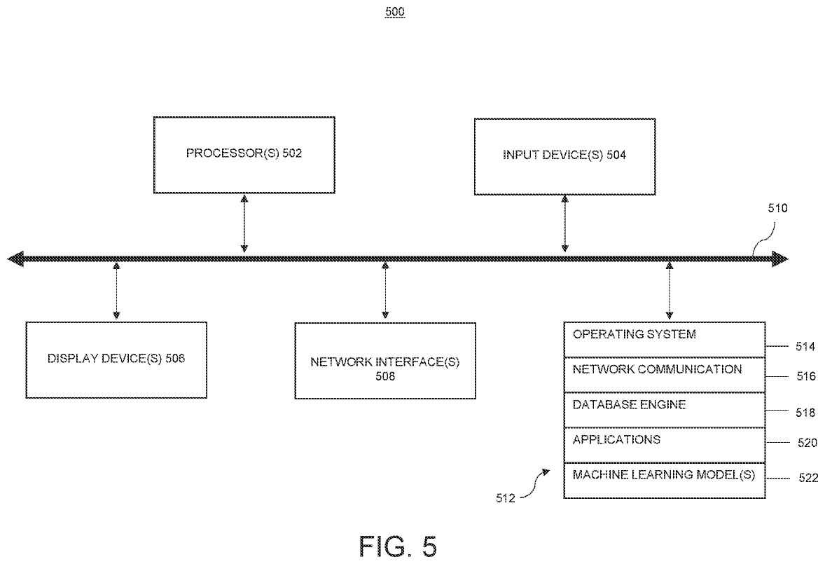

FIG. 5 shows a block diagram of an example computing device 500 that implements various features and processes, based on the principles disclosed herein. For example, computing device 500 may function as a server 106, end user device(s) 102, agent device(s) 104, or a portion or combination thereof in some embodiments. The computing device 500 also performs one or more steps of the methods 200 and 300 disclosed herein. The computing device 500 is implemented on any electronic device that runs software applications derived from compiled instructions, including without limitation personal computers, servers, smart phones, media players, electronic tablets, game consoles, email devices, etc. In some implementations, the computing device 500 includes one or more processors 502, one or more input devices 504, one or more display devices 506, one or more network interfaces 508, and one or more computer-readable media 512. Each of these components is be coupled by a bus 510.

Display device 506 includes any display technology, including but not limited to display devices using Liquid Crystal Display (LCD) or Light Emitting Diode (LED) technology. Processor(s) 502 uses any processor technology, including but not limited to graphics processors and multi-core processors. Input device 504 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 512 includes any non-transitory computer readable medium that provides instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 includes various instructions 514 for implementing an operating system (e.g., Mac OS®, Windows®, Linux). The operating system 514 may be multi-user, multiprocessing, multitasking, multithreading, real-time, and the like. The operating system 514 performs basic tasks, including but not limited to: recognizing input from input device 504; sending output to display device 506; keeping track of files and directories on computer-readable medium 812; controlling peripheral devices (e.g., disk drives, printers, etc.) which can be controlled directly or through an I/O controller (not shown); and managing traffic on bus 510. Network communications instructions 516 establish and maintain network connections (e.g., software for implementing communication protocols, such as TCP/IP, HTTP, Ethernet, telephony, etc.).

Database engine 518 may interact with different databases accessed by the computing device 500. For example, the databases may comprise training data to train machine learning models. The databases may also provide access to real-time data to deploy the trained machine learning models.

Applications 520 may comprise an application that uses or implements the processes described herein and/or other processes. The processes may also be implemented in the operating system.

Machine learning model(s) 522 may comprise one or more machine learning models (e.g., light GBMs) trained and deployed to implement one or more prediction functionalities described throughout this disclosure.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer-implemented method of predicting an abandonment of a computer application, the method comprising:
retrieving, in real-time, a time series of non-clickstream numerical values displayed to a user by a sequence of interfaces of the computer application as the user navigates through the computer application, each non-clickstream numerical value in the time series being non-clickable, the computer application being a tax preparation application, the non-clickstream numerical values being a sequence of refund amounts displayed by the tax preparation application;
extracting a plurality of non-clickstream features from the time series of non-clickstream numerical values, the plurality of non-clickstream features comprising:
symmetricity of a distribution of the time series of non-clickstream numerical values,
non-linearity of the time series of non-clickstream numerical values,
complexity measurement of the time series of non-clickstream numerical values,
entropy of the time series of non-clickstream numerical values,
sum of squared values of the time series of non-clickstream numerical values,
number of peaks of at least support five in the time series of non-clickstream numerical values,
autocorrelation with lag value of 2 of the time series of non-clickstream numerical values, and
value in the time series of non-clickstream numerical values that is greater than 75% of ordered values;
deploying a light gradient boost model on the plurality of extracted non-clickstream features to determine whether the user will continue using the computer application or abandon using the computer application, the light gradient boost model being trained using a supervised approach on a plurality of historical features and corresponding labeled outcomes; and
generating a customized message for display by the computer application responsive to determining that the user will abandon using the computer application.

2. (canceled)

3. The computer-implemented method of claim 1, wherein deploying the light gradient boost model further comprises:
deploying the light gradient boost model to generate a first binary outcome indicating that the user will continue using the computer application or a second binary outcome indicating that the user will abandon using the computer application.

4. The computer-implemented method of claim 1, wherein retrieving the time series of non-clickstream numerical values comprises:
retrieving, from the sequence of interfaces, the time series containing a predetermined number of non-clickstream numerical values.

5. The computer-implemented method of claim 1, further comprising:
determining that the retrieved time series of the non-clickstream numerical values contain less than a predetermined number of non-clickstream numerical values; and
prepending the retrieved time of series of non-clickstream numerical values with zeroes until a number of non-clickstream numerical values reaches the predetermined number of non-clickstream numerical values.

6. The computer-implemented method of claim 1, wherein generating the customized message comprises:
generating the customized message based on a Shapely explanation model.

7. The computer-implemented method of claim 1, wherein generating the customized message comprises:
generating, in real time, an explanation message based on a Shapely explanation model.

8. The computer-implemented method of claim 1, wherein generating the customized message comprises:
generating a discount offer for display by the computer application.

9. (canceled)

10. The computer-implemented method of claim 1, wherein extracting the plurality of non-clickstream features from the time series of the non-clickstream numerical values further comprises:
extracting, from the time series of the non-clickstream numerical values, at least one of:
number of times a subsequence of size 3 occurs where a first value is negative and a third value is positive or vice versa in the time series of non-clickstream numerical values;
whether a standard deviation is higher than 4 times a range of the time series of non-clickstream numerical values;
ratio of values more than 2 times the standard deviation away from a mean of the time series of non-clickstream numerical values;
percentage of repeated values in the time series of non-clickstream numerical values;
first position of a minimum value in the time series of non-clickstream numerical values;
first position of a maximum value in the time series of non-clickstream numerical values;
last position of the minimum value in the time series of non-clickstream numerical values;
last position of the maximum value in the time series of non-clickstream numerical values;
length of a consecutive subsequence greater than the mean of the time series of non-clickstream numerical values;
length of a consecutive subsequence less than the mean of the time series of non-clickstream numerical values;
sum over an absolute value of consecutive changes in the time series of non-clickstream numerical values;
number of distinct values in the time series of non-clickstream numerical values;
kurtosis of time series of non-clickstream numerical values;
skewness of the time series of non-clickstream numerical values;
number of values greater than the mean in the time series of non-clickstream numerical values;
mean over absolute differences between consecutive values in the time series of non-clickstream numerical values; and
whether duplicate values exist in the time series of non-clickstream numerical values.

11. A system for predicting an abandonment of a computer application, the system comprising:
a non-transitory medium storing computer program instructions; and
at least one processor configured to execute the computer program instructions to cause operations comprising:
retrieving, in real-time, a time series of non-clickstream numerical values displayed to a user by a sequence of interfaces of the computer application as the user navigates through the computer application, each non-clickstream numerical value in the time series being non-clickable, the computer application being a tax preparation application, the non-clickstream numerical values being a sequence of refund amounts displayed by the tax preparation application;
extracting a plurality of non-clickstream features from the time series of non-clickstream numerical values, the plurality of non-clickstream features comprising:
symmetricity of a distribution of the time series of non-clickstream numerical values,
non-linearity of the time series of non-clickstream numerical values,
complexity measurement of the time series of non-clickstream numerical values,
entropy of the time series of non-clickstream numerical values,
sum of squared values of the time series of non-clickstream numerical values,
number of peaks of at least support five in the time series of non-clickstream numerical values,
autocorrelation with lag value of 2 of the time series of non-clickstream numerical values, and
value in the time series of non-clickstream numerical values that is greater than 75% of ordered values;
deploying a light gradient boost model on the plurality of extracted non-clickstream features to determine whether the user will continue using the computer application or abandon using the computer application, the light gradient boost model being trained using a supervised approach on a plurality of historical features and corresponding labeled outcomes; and
generating a customized message for display by the computer application responsive to determining that the user will abandon using the computer application.

12. (canceled)

13. The system of claim 11, wherein deploying the light gradient boost model further comprises:
deploying the light gradient boost model to generate a first binary outcome indicating that the user will continue using the computer application or a second binary outcome indicating that the user will abandon using the computer application.

14. The system of claim 11, wherein retrieving the time series of non-clickstream numerical values comprises:
retrieving, from the sequence of interfaces, the time series containing a predetermined number of non-clickstream numerical values.

15. The system of claim 11, further comprising:
determining that the retrieved time series of the non-clickstream numerical values contain less than a predetermined number of non-clickstream numerical values; and
prepending the retrieved time of series of non-clickstream numerical values with zeroes until a number of non-clickstream numerical values reaches the predetermined number of non-clickstream numerical values.

16. The system of claim 11, wherein generating the customized message comprises:
generating the customized message based on a Shapely explanation model.

17. The system of claim 11, wherein generating the customized message comprises:
generating, in real time, an explanation message based on a Shapely explanation model.

18. The system of claim 11, wherein generating the customized message comprises:
generating a discount offer for display by the computer application.

19. (canceled)

20. The system of claim 11, wherein extracting the plurality of non-clickstream features from the time series of the non-clickstream numerical values further comprises:
extracting, from the time series of the non-clickstream numerical values, at least one of:
number of times a subsequence of size 3 occurs where a first value is negative and a third value is positive or vice versa in the time series of non-clickstream numerical values;
whether a standard deviation is higher than 4 times a range of the time series of non-clickstream numerical values;
ratio of values more than 2 times the standard deviation away from a mean of the time series of non-clickstream numerical values;
percentage of repeated values in the time series of the non-clickstream numerical values;
first position of a minimum value in the time series of non-clickstream numerical values;
first position of a maximum value in the time series of non-clickstream numerical values;
last position of the minimum value in the time series of non-clickstream numerical values;
last position of the maximum value in the time series of non-clickstream numerical values;
length of a consecutive subsequence greater than the mean of the time series of non-clickstream numerical values;
length of a consecutive subsequence less than the mean of the time series of non-clickstream numerical values;
sum over an absolute value of consecutive changes in the time series of non-clickstream numerical values;
number of distinct values in the time series of non-clickstream numerical values;
kurtosis of time series of non-clickstream numerical values;
skewness of the time series of non-clickstream numerical values;
number of values greater than the mean in the time series of the non-clickstream numerical values;
mean over absolute differences between consecutive values in the time series of non-clickstream numerical values; and
whether duplicate values exist in the time series of non-clickstream numerical values.
